(19) United States
(12) Patent Application Publication
(10) Pub. No.: US 2002/0163768 A1
(43) Pub. Date: Nov. 7, 2002

(54) Electrostatic discharge protection circuit using diodes

(75) Inventors: Gue-Hyung Kwon, Ansan-city (KR); Won-Hyung Pong, Suwon-city (KR)

Correspondence Address: F. Chau & Associates, LLP, Suite 501, 1900 Hempstead Turnpike, East Meadow, NY, 11554, US

(73) Assignee: Samsung Electronics Co., Ltd.

(21) Appl. No.: 10/090,904

(22) Filed: Mar. 5, 2002

(30) Foreign Application Priority Data
May 4, 2001 (KR) 2001-24382

(51) Int. Cl. H02H 9/00

(52) U.S. Cl. 361/56

(57) ABSTRACT

An electrostatic discharge protection circuit, which is arranged between a pad input terminal and a circuit device, includes a first diode protection circuit unit and a second diode protection circuit unit. The first diode protection circuit unit includes a first diode and a second diode, which are connected in parallel between the pad input terminal and an input voltage terminal and face opposite directions. The second diode protection circuit unit includes a third diode and a fourth diode, which are connected in parallel between the pad input terminal and a substrate terminal and face opposite directions. The electrostatic discharge protection circuit can make electrostatic discharge current flow by making all the diodes operate only in a forward direction, irrespective of electrostatic discharge stress generated from the outside.

### BACKGROUND OF THE INVENTION

1. Field of the Invention

The present disclosure relates to an electrostatic discharge protection circuit, and more particularly, to a circuit for protecting the input and output terminals of an integrated circuit from electrostatic discharge by using diodes.

2. Description of the Related Art

In general, during testing or normal operation of integrated circuits (ICs), it is necessary to prevent damage to the integrated circuits from being caused by electrostatic discharge (ESD) stress by directly connecting an electrostatic discharge protection circuit to the input or output terminal of each of the integrated circuits.

FIG. 1 is a circuit diagram of a conventional electrostatic discharge protection circuit using diodes. Referring to FIG. 1, a conventional electrostatic discharge protection circuit 10 protects a circuit device 12 from ESD stress generated from a pad input terminal 11. The protection circuit 10 includes a first diode D₁ and a second diode D₂. The first diode D₁ is connected between the pad input terminal 11 and an input voltage terminal V_{DD}. The second diode D₂ is connected between the pad input terminal 11 and a substrate terminal V_{SS}. The anode of the first diode D₁ is connected to the pad input terminal 11, and the cathode of the first diode D₁ is connected to the input voltage terminal V_{DD}. The anode of the second diode D₂ is connected to the substrate terminal V_{SS} and the cathode of the second diode D₂ is connected to the pad input terminal 11.

If ESD stress is generated from the pad input terminal 11 by a positive voltage applied to the pad input terminal 11, ESD current generated by ESD stress flows into the input voltage terminal V_{DD} due to the first diode D₁ allowing current flow in a forward direction. Then, if the second diode D₂ breaks down, the ESD current flows into the substrate terminal V_{SS} due to the second diode allowing current flow in a reverse direction. If a negative voltage is applied to the pad input terminal 11, ESD current generated by ESD stress flows from the substrate terminal V_{SS} due to the second diode D₂ allowing current flow in a forward direction. Then, if the first diode D₁ breaks down, the ESD current flows from the input voltage terminal V_{DD} due to the first diode D₁ allowing current flow in a reverse direction. Thus, the circuit device 12 can be protected from ESD stress generated from the outside by making a considerable amount of ESD current flow through the input voltage terminal V_{DD} and/or the substrate terminal V_{SS} via the first and second diodes D₁ and/or D₂, respectively.

However, in the conventional electrostatic discharge protection circuit 10, a diode allows current flow in a reverse direction. In other words, if a positive voltage or a negative voltage is applied to the pad input terminal 11, one of the first and second diodes D₁ and D₂ allows current flow in a forward diode direction and the other allows current flow in a reverse diode direction. In general, if a diode allows current flow in a reverse diode direction, a high power is dissipated as a result of the high voltage. Accordingly, if an electrostatic discharge protection circuit includes a diode allowing current flow in a reverse diode direction like the conventional electrostatic discharge protection circuit 10, the characteristics of the diode may be deteriorated by the high power.

### SUMMARY OF THE INVENTION

The above-described and other drawbacks and deficiencies of the prior art are addressed by an electrostatic discharge protection circuit that uses diodes to flow current in only a forward diode direction, and thus dissipates a relatively low power at the diodes.

Accordingly, there is provided an electrostatic discharge protection circuit arranged between a pad input terminal and a circuit device. The electrostatic discharge protection circuit includes a first diode protection circuit unit and a second diode protection circuit unit. The first diode protection circuit unit includes a first diode and a second diode, which are connected in parallel between the pad input terminal and the input voltage terminal and face opposite directions. The second diode protection circuit unit includes a third diode and a fourth diode, which are connected in parallel between the pad input terminal and a substrate terminal and face opposite directions.

Preferably, the anode of the first diode and the cathode of the second diode are connected to the pad input terminal, and the cathode of the first diode and the anode of the second diode are connected to the input voltage terminal, in which case the second diode may be comprised of a plurality of diodes connected in series. Preferably, the number of the plurality of diodes is determined such that when an input voltage is applied to the input voltage terminal, a short circuit between the pad input terminal and the input voltage terminal is prevented from occurring.

Preferably, the first diode is comprised of a plurality of diodes connected in series.

Preferably, the cathode of the third diode and the anode of the fourth diode are connected to the pad input terminal, and the anode of the third diode and the cathode of the fourth diode are connected to the substrate terminal, in which case the fourth diode may be comprised of a plurality of diodes connected in series. Preferably, the number of this plurality of diodes is determined such that when an input voltage is applied to the input voltage terminal, a short circuit between the pad input terminal and the substrate terminal is prevented from occurring.

Preferably, the third diode is comprised of a plurality of diodes connected in series.

### BRIEF DESCRIPTION OF THE DRAWINGS

The above features and advantages of the present disclosure will become more apparent by describing in detail preferred embodiments thereof with reference to the attached drawings, in which:

FIG. 1 is a circuit diagram of a conventional electrostatic discharge protection circuit using diodes;

FIG. 2 is a circuit diagram of an electrostatic discharge protection circuit according to a first embodiment of the present disclosure;

FIGS. 3A and 3B are cross-sectional views illustrating the structure of diodes of the electrostatic discharge protection circuit of FIG. 2;

FIG. 4 is a circuit diagram of an electrostatic discharge protection circuit according to a second embodiment of the present disclosure;

FIGS. 5A and 5B are cross-sectional views illustrating the structure of diodes of the electrostatic discharge protection circuit of FIG. 4;

FIG. 6 is a circuit diagram of an electrostatic discharge protection circuit according to a third embodiment of the present disclosure; and

FIGS. 7A and 7B are cross-sectional views illustrating the structure of diodes of the electrostatic discharge protection circuit of FIG. 6.

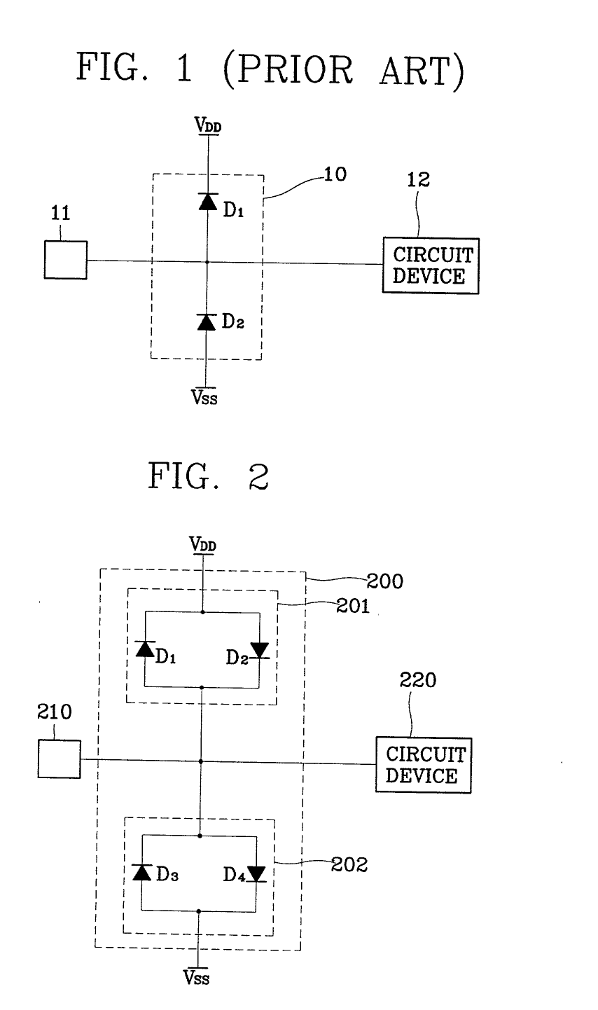

### DETAILED DESCRIPTION OF THE INVENTION

The present disclosure will now be described more fully with reference to the accompanying drawings, in which preferred embodiments of the disclosure are shown. This disclosure may, however, be embodied in many different forms and should not be construed as being limited to the embodiments set forth herein. Rather, these embodiments are provided so that this disclosure will be thorough and complete and will fully convey the concept of the disclosure to those skilled in the art.

FIG. 2 is a circuit diagram of an electrostatic discharge protection circuit 200 according to a first embodiment of the present disclosure. Referring to FIG. 2, the electrostatic discharge protection circuit 200 according to the present embodiment protects a circuit device 220 from ESD stress generated from a pad input terminal 210. The electrostatic discharge protection circuit 200 includes a first diode protection circuit unit 201 and a second diode protection circuit unit 202. The first diode protection circuit unit 201 is positioned between the pad input terminal 210 and an input voltage terminal V_{DD}. The second diode protection circuit unit 202 is positioned between the pad input terminal 210 and a substrate terminal V_{SS}. Here, the input voltage terminal V_{DD} is a terminal for applying a bias to a high concentration drain region of a field effect transistor constituting the circuit device 220 and the substrate terminal V_{SS} is connected to a semiconductor substrate on which the protection circuit 200 and the circuit device 220 are formed.

The first diode protection circuit unit 201 includes a first diode D₁ and a second diode D₂. The first and second diodes D₁ and D₂ are positioned to face opposite directions and are connected in parallel. In other words, the anode of the first diode D₁ and the cathode of the second diode D₂ are connected to the pad input terminal 210, and the cathode of the first diode D₁ and the anode of the second diode D₂ are connected to the input voltage terminal V_{DD}.

The second diode protection circuit unit 202 includes a third diode D₃ and a fourth diode D₄. The third and fourth diodes D₃ and D₄ are positioned to face opposite directions and are connected in parallel. In other words, the cathode of the third diode D₃ and the anode of the fourth diode D₄ are connected to the pad input terminal 210 and the anode of the third diode D₃ and the cathode of the fourth diode D₄ are connected to the substrate terminal V_{SS}.

In the electrostatic discharge protection circuit 200, if ESD stress is generated from the pad input terminal 210, and thus a positive voltage is applied, ESD current generated by the ESD stress flows into the input voltage terminal V_{DD} and the substrate terminal V_{SS} via the first diode D₁ of the first diode protection circuit unit 201 and the fourth diode D₄ of the second diode protection circuit unit 202, respectively. At this time, the first and fourth diodes D₁ and D₄ allow current flow in a forward direction and thus provide a path for the ESD current to flow. A reverse-biased voltage is applied to the second diode D₂ of the first diode protection circuit unit 201 and the third diode D₃ of the second diode protection circuit unit 202. As a result, the second and third diodes D2 and D3 form an open circuit that would allow a considerable amount of current to flow in a reverse direction if they break down. In order to make the second and third diodes D₂ and D₃ break down, the voltage difference across the second and third diodes D₂ and D₃ must be no less than a predetermined voltage. However, since a considerable amount of ESD current leaks through the first and fourth diodes D₁ and D₄, the predetermined voltage is not reached and the second and third diodes D₂ and D₃ do not break down. As a result, the second and third diodes D₂ and D₃ are maintained in an open circuit state, that is, a reverse-biased state until all of the ESD current flows into the input voltage terminal V_{DD} and the substrate terminal V_{SS}.

In a case where ESD stress is generated from the pad input terminal 210, and thus a negative voltage is applied, ESD current generated by the ESD stress is discharged by flowing current through a diode in a forward direction. In other words, in this case, the ESD current generated by the ESD stress flows from the input voltage terminal V_{DD} and the substrate terminal V_{SS} via the second diode D₂ of the first diode protection circuit unit 201 and the third diode D₃ of the second diode protection circuit unit 202. At this time, the second and third diodes D₂ and D₃ allow current flow in a forward direction and thus provide a path for the ESD current to flow, and a reverse-biased voltage is applied to the first diode D₁ of the first diode protection circuit unit 201 and the fourth diode D₄ of the second diode protection circuit unit 202. In a manner similar to that described above, since a considerable amount of ESD current passes through the second and third diodes D₂ and D₃, the first and fourth diodes D₁ and D₄ do not break down. Thus, the first and fourth diodes D₁ and D₄ are maintained in an open circuit state until all of the ESD current flows from the input voltage terminal V_{DD} and the substrate terminal V_{SS}.

As described above, the electrostatic discharge protection circuit 200 according to the present embodiment provides a path for ESD current to flow through a diode in the forward direction and thus can prevent the characteristics of the diode from being deteriorated due to the diode operating in the reverse direction.

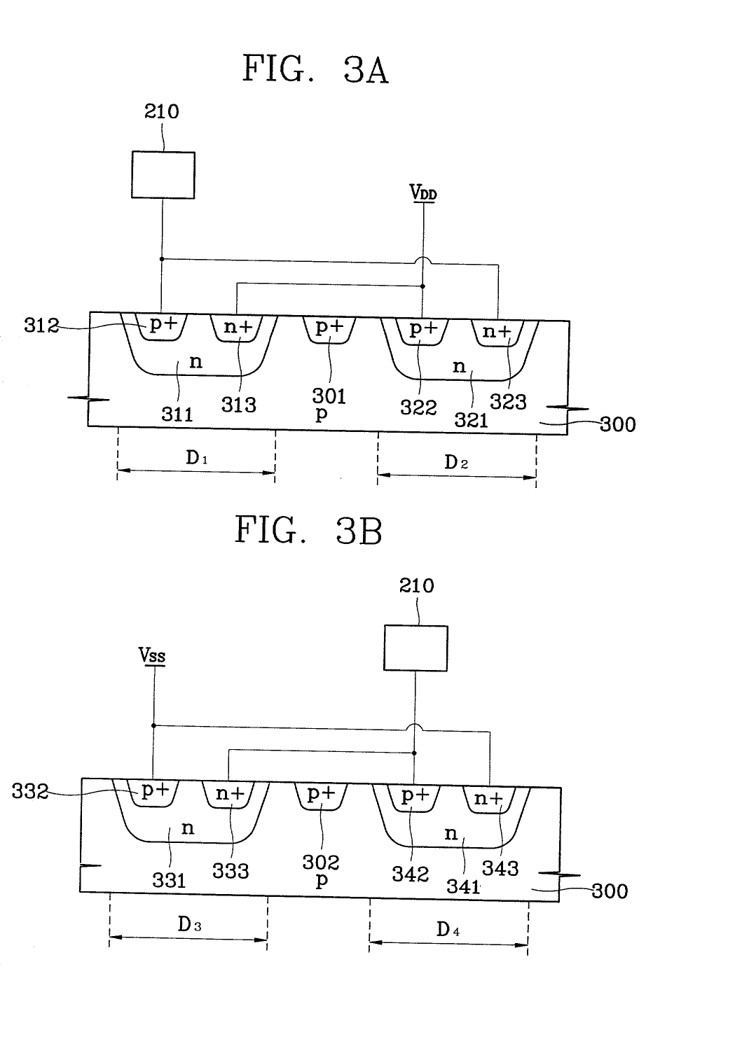

FIGS. 3A and 3B are cross-sectional views of the diode structure of the electrostatic discharge protection circuit of FIG. 2. Specifically, FIG. 3A is a cross-sectional view of the first diode protection circuit unit 201 of the electrostatic discharge protection circuit 200 of FIG. 2, and FIG. 3B is a cross-sectional view of the second diode protection circuit 202 of the electrostatic discharge protection circuit 200 of FIG. 2.

Referring to FIG. 3A, a first well region 311 of a second conductivity type (n-type) and a second well region 321 of the second conductivity type (n-type) are formed on predetermined regions of a semiconductor substrate 300 of a first conductivity type (p-type). In the first well region 311, the first diode D₁ is formed, and in the second well region 321, the second diode D₂ is formed. The first and second well regions 311 and 321 are a predetermined distance apart. A p+-type impurity region 301 for applying a bias to the semiconductor substrate 300 is arranged between the first and second well regions 311 and 321.

In the first well region 311, a first p+-type region 312 and a first n+-type region 313 are formed a predetermined distance apart. The first p+-type region 312 is the anode of the first diode D₁, and the first n+-type region 313 is the cathode of the first diode D₁. In the second well region 321, a second p+-type region 322 and a second n+-type region 323 are formed a predetermined distance apart. The second p+-type region 322 is the anode of the second diode D₂, and the second n+-type region 323 is the cathode of the second diode D₂. A metal wire is formed to connect the first p+-type region 312 of the first diode D₁ and the second n+-type region 323 of the second diode D₂ to the pad input terminal 210. A metal wire is also formed to connect the first n+-type region 313 of the first diode D₁ and the second p+-type region 322 of the second diode D₂ to the input voltage terminal V_{DD}.

Referring to FIG. 3B, a third well region 331 of the first conductivity type (n-type) and a fourth well region 341 of the first conductivity type (n-type) are formed on predetermined regions of the semiconductor substrate 300 of the second conductivity type (p-type). In the third well region 331, the third diode D₃ is formed, and in the fourth well region 341, the fourth diode D₄ is formed. The third and fourth well regions are a predetermined distance apart. A p+-type impurity region 302 for applying a bias to the semiconductor substrate 300 is arranged between the third and fourth well regions 331 and 341.

In the third well region 331, a third p+-type region 332 and a third n+-type region 333 are formed a predetermined distance apart. The third p+-type region 332 is the anode of the third diode D₃, and the third n+-type region 333 is the cathode of the third diode D₃. In the fourth well region 341, a fourth p+-type region and a fourth n+-type region 343 are formed a predetermined distance apart. The fourth p+-type region 342 is the anode of the fourth diode D₄, and the fourth n+-type region 343 is the cathode of the fourth diode D₄. A metal wire is formed to connect the third p+-type region 332 of the third diode D₃ and the fourth n+-type region 343 of the fourth diode D₄ to the substrate terminal V_{SS}. In addition, a metal wire is formed to connect the third n+-type region 333 of the third diode D₃ and the fourth p+-type region 342 of the fourth diode D₄ to the pad input terminal 210.

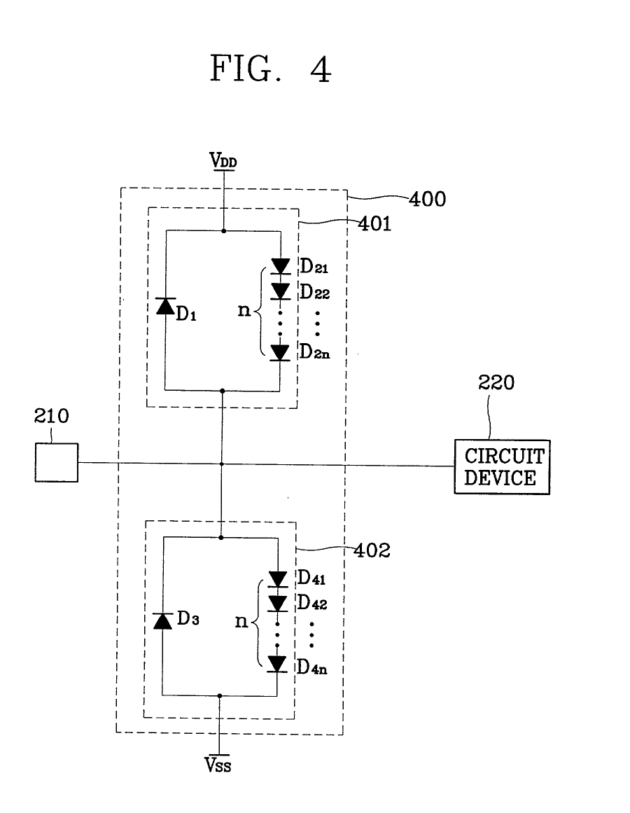

FIG. 4 is a circuit diagram of an electrostatic discharge protection circuit 400 according to a second embodiment of the present disclosure. The same reference numerals in FIGS. 2 and 4 represent the same element, and thus their description will be omitted. The present embodiment is different from the first one in that a first diode protection circuit unit 401 includes a plurality of second diodes D₂₁, D₂₂, . . . , D₂ₙ connected in series and a second diode protection circuit unit includes a plurality of fourth diodes D₄₁, D₄₂, . . . , D₄ₙ connected in series.

Specifically, referring to FIG. 4, the electrostatic discharge protection circuit 400 according to the present embodiment includes the first diode protection circuit unit 401 and the second diode protection circuit unit 402. The first diode protection circuit unit 401 is positioned between the pad input terminal 210 and the input voltage terminal V_{DD}. The second diode protection circuit unit 402 is positioned between the pad input terminal 210 and the substrate terminal V_{SS}. The first diode protection circuit unit 401 includes the first diode D₁ and the plurality of second diodes D₂₁, D₂₂, . . . , D₂ₙ. The first diode D₁ and the plurality of second diodes D₂₁, D₂₂, . . . , D₂ₙ face opposite directions and are connected in parallel. The second diode protection circuit unit 402 includes the third diode D₃ and the plurality of fourth diodes D₄₁, D₄₂, . . . , D₄ₙ. The third diode D₃ and the plurality of fourth diodes D₄₁, D₄₂, . . . , D₄ₙ face opposite directions and are connected in parallel.

In the present embodiment, the second diodes D₂₁, D₂₂, . . . D₂ₙ and the fourth diodes D₄₁, D₄₂, . . . , D₄ₙ each have n diodes that face the same direction and are connected in series. In order to normally operate the circuit device 220, a short-circuit must be prevented from occurring between the pad input terminal 210 and the input voltage terminal V_{DD} in a case when a predetermined voltage is applied to the pad input terminal 210 and the input voltage terminal V_{DD}. For this, a plurality of diodes connected in series between the pad input terminal 210 and the input voltage terminal V_{DD} are needed. In other words, if the sum of turn-on voltages of diodes connected in series is greater than a voltage difference between the pad input terminal 210 and the input voltage terminal V_{DD}, the diodes are not turned on, and thus the pad input terminal 210 and the input voltage terminal V_{DD} are electrically disconnected. As a result, the circuit device 220 can be operated normally. Therefore, the number (n) of diodes connected in series is determined such that the sum of turn-on voltages of the n diodes is maintained to be greater than a voltage difference between the pad input terminal 210 and the input voltage terminal V_{DD}.

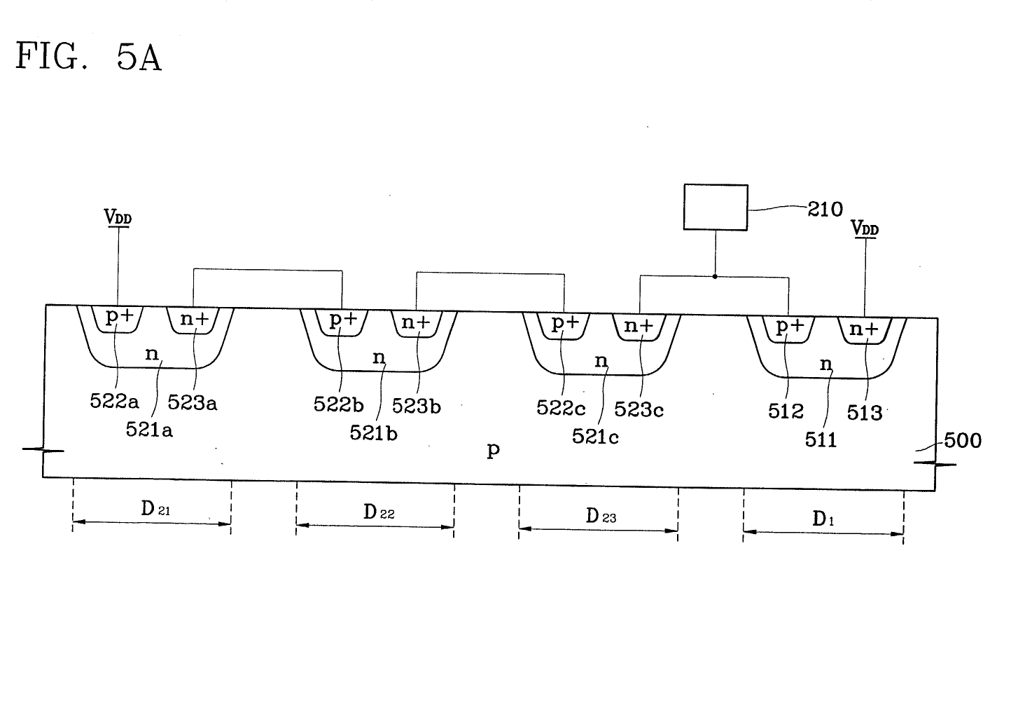

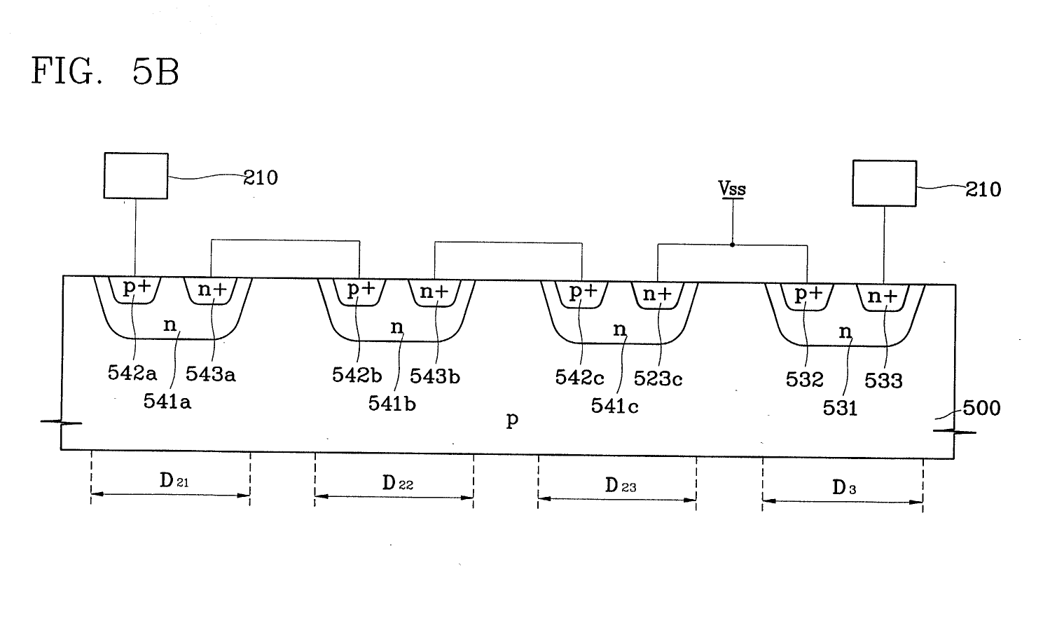

FIGS. 5A and 5B are cross-sectional views of the diode structure of the electrostatic discharge protection circuit 400 of FIG. 4. Specifically, FIG. 5A is a cross-sectional view of the first diode protection circuit unit 401 of the electrostatic discharge protection circuit 400 of FIG. 4, and FIG. 5B is a cross-sectional view of the second diode protection circuit unit 402 of the electrostatic discharge protection circuit 400 of FIG. 4. In FIGS. 5A and 5B, only second diodes D₂₁, D₂₂, and D₂₃ of the plurality of second diodes D₂₁, D₂₂, . . . D₂ₙ and fourth diodes D₄₁, D₄₂, and D₄₃ of the plurality of fourth diodes D₄₁, D₄₂, . . . , D₄ₙ are illustrated.

Referring to FIG. 5A, a first well region 511 of the first conductivity type (n-type) and second well regions 521a, 521b, and 521c of the second conductivity type (n-type) are formed on predetermined regions of a semiconductor substrate 500 of the first conductivity type (p-type). The first diode D₁ is formed in the first well region 511, and the second diodes D₂₁, D₂₂, and D₂₃ are formed in the second well regions 521a, 521b, and 521c, respectively.

In the first well region 511, a first p+-type region 512 and a first n+-type region 513 are formed a predetermined distance apart. The first p+-type region 512 is the anode of the first diode D₁, and the first n+-type region 513 is the cathode of the first diode D₁. Second p+-type regions 522a, 522b, and 522c and second n+-type regions 523a, 523b, and 523c are formed a predetermined distance apart, respectively, in their respective second well regions 521a, 521b, and 521c. The second p+-type regions 522a, 522b, and 522c are the anodes of the second diodes D₂₁, D₂₂, and D₂₃, respectively, and the second n+-type regions 523a, 523b, and 523c are the cathodes of the second diodes D₂₁, D₂₂, and D₂₃, respectively. A metal wire is formed to connect the first p+-type region 512 of the first diode D₁ and the second n+-type region 523c of the second diode D₂₃ to the pad input terminal 210. A metal wire is formed to connect the first n+-type region 513 of the first diode D₁ and the second p+-type region 522a of the second diode D₂₁ to the input voltage terminal V_{DD}. Metal wires are also formed to connect the second n+-type region 523a of the second diode D₂₁with the second p+-type region 522b of the second diode D₂₂, as well as the second n+-type region 523b of the second diode D₂₂ with the second p+-type region 522c of the second diode D₂₃ in series, respectively.

Referring to FIG. 5B, a third well region 531 of the second conductivity type (n-type) and fourth well regions 541a, 541b, and 541c of the second conductivity type (n-type) are formed on predetermined regions of the semiconductor substrate 500 of the first conductivity type (p-type). The third diode D₃ is formed in the third well region 531, and the fourth diodes D₄₁, D₄₂, and D₄₃ are formed in the fourth well regions 541a, 541b, and 541c, respectively.

A third p+-type region 532 and a third n+-type region 533 are formed a predetermined distance apart in the third well region 531. The third p+-type region 532 is the anode of the third diode D₃, and the third n+-type region 533 is the cathode of the third diode D₃. Fourth p+-type regions 542a, 542b, and 542c and fourth n+-type regions 543a, 543b, and 543c are formed a predetermined distance apart, respectively, in their respective fourth well regions 541a, 541b, and 541c. The fourth p+-type regions 542a, 542b, and 542c are the anodes of the fourth diodes D₄₁, D₄₂, and D₄₃, respectively, and the fourth n+-type regions 543a, 543b, and 543c are the cathodes of the fourth diodes D₄₁, D₄₂, and D₄₃, respectively. A metal wire is formed to connect the third p+-type region 532 of the third diode D₃ and the fourth n+-type region 543c of the fourth diode D₄₃ to the substrate terminal V_{SS}. A metal wire is formed to connect the third n+-type region 533 of the third diode D₃ and the fourth p+-type region 542a of the fourth diode D₄₁ to the pad input terminal 210. Metal wires are also formed to connect the fourth n+-type region 543a of the fourth diode D₄₁ with the fourth p+-type region 542b of the fourth diode D₄₂, and the fourth n+-type region 543b of the fourth diode D₄₂ with the fourth p+-type region 542c of the fourth diode D₄₃, in series, respectively.

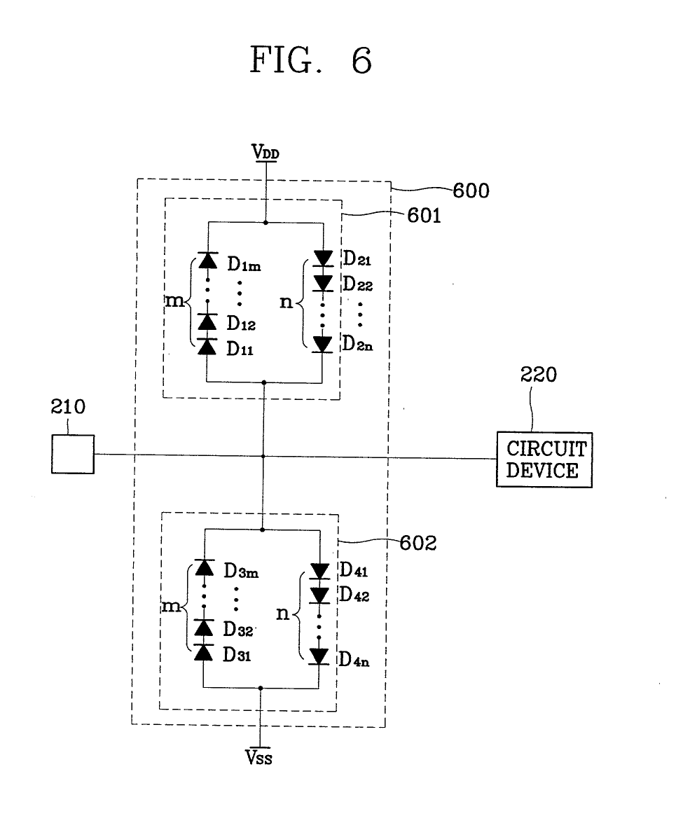

FIG. 6 is a circuit diagram of an electrostatic discharge protection circuit 600 according to a third embodiment of the present disclosure. The same reference numerals in FIGS. 2, 4, and 6 represent the same elements, and thus their descriptions will be omitted. The present embodiment differs from the first and second embodiments in that a first diode protection circuit unit 601 includes a plurality of first diodes D₁₁, D₁₂, . . . , D₁ₘ connected in series as well as the plurality of second diodes D₂₁, D₂₂, . . . , D₂ₙ connected in series, and the second diode protection circuit unit 602 includes a plurality of third diodes D₃₁, D₃₂, . . . , D₃ₘ connected in series as well as the plurality of fourth diodes D₄₁, D₄₂, . . . , D₄ₙ connected in series.

Referring to FIG. 6, the electrostatic discharge protection circuit 600 includes the first diode protection circuit unit 601 and the second diode protection circuit unit 602. The first diode protection circuit unit 601 is positioned between the pad input terminal 210 and the input voltage terminal V_{DD}. The second diode protection circuit unit 602 is positioned between the pad input terminal 210 and the substrate terminal V_{SS}. The first diode protection unit 601 includes the plurality of first diodes D₁₁, D₁₂, . . . , D₁ₘ and the plurality of second diodes D₂₁, D₂₂, . . . , D₂ₙ. The plurality of the first diodes D₁₁, D₁₂, . . . , D₁ₘ and the plurality of the second diodes D₂₁, D₂₂, . . . D₂ₙ face opposite directions and are connected in parallel. The second diode protection circuit unit 602 includes the plurality of third diodes D₃₁, D₃₂, . . . , D₃ₘ and the plurality of fourth diodes D₄₁, D₄₂, . . . , D₄ₙ. The plurality of third diodes D₃₁, D₃₂, . . . , D₃ₘ and the plurality of fourth diodes D₄₁, D₄₂, . . . , D₄ₙ face opposite directions and are connected in parallel.

In the present embodiment, the first diodes D₁₁, D₁₂, . . . D₁ₘ and the third diodes D₃₁, D₃₂, . . . , D₃ₘ each have m diodes that face the same direction and are connected in series. The electrostatic discharge protection circuit having a structure as described above is advantageous in protecting a circuit device used at a high frequency. In other words, under a high frequency condition, the equivalent capacitance of a diode strongly affects the electrical characteristics of a circuit. Thus, in order to maintain a predetermined magnitude or less of capacitance, it is necessary to limit the size of a diode. However, the present disclosure reduces the equivalent capacitance of diodes by connecting the diodes in series instead. Thus, the present disclosure can use a larger diode than one used in the prior art.

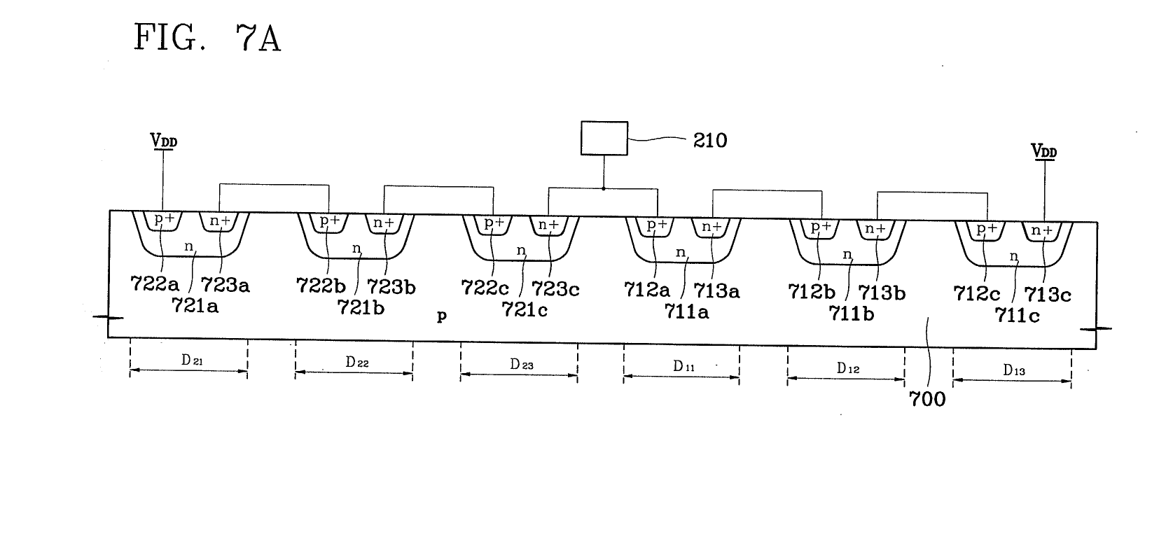

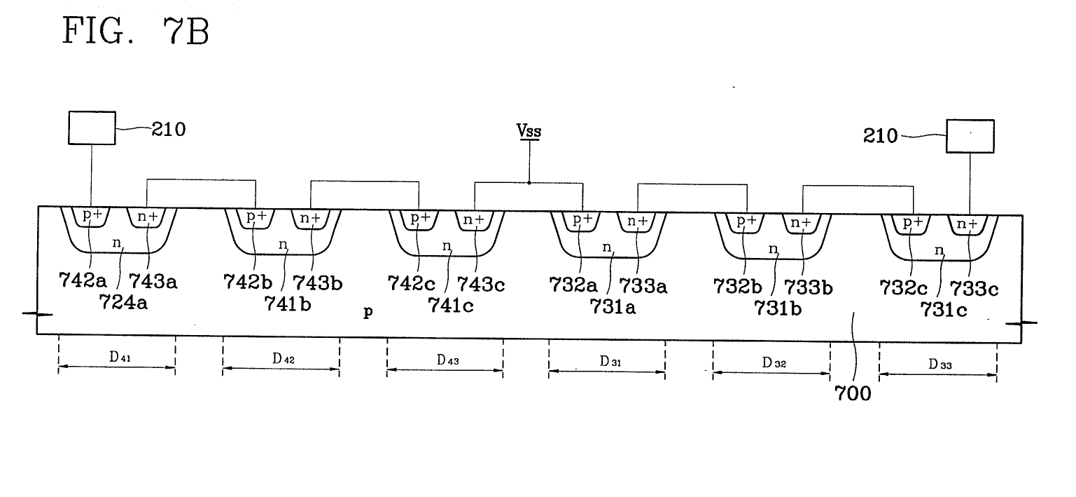

FIGS. 7A and 7B are cross-sectional views of the diode structure of the electrostatic discharge protection circuit of FIG. 6. In FIGS. 7A and 7B, only first diodes D₁₁, D₁₂, and D₁₃, of the plurality of first diodes D₁₁, D₁₂, . . . , D₁ₘ, second diodes D₂₁, D₂₂, and D₂₃ of the plurality of second diodes D₂₁, D₂₂, . . . , D₂ₙ, third diodes D₃₁, D₃₂, and D₃₃ of the plurality of third diodes D₃₁, D₃₂, . . . , D₃ₘ , and fourth diodes D₄₁, D₄₂, and D₄₃ of the plurality of fourth diodes D₄₁, D₄₂, . . . , D₄ₙ are illustrated.

Referring to FIG. 7A, first well regions 711a, 711b, and 711c of the second conductivity type (n-type) and second well regions 721a, 721b, and 721c of the second conductivity type (n-type) are formed on predetermined regions of a semiconductor substrate 700 of the first conductivity type (p-type). The first diodes D₁₁, D₁₂, and D₁₃ are formed in the first well regions 711a, 711b, and 711c, respectively. The second diodes D₂₁, D₂₂, and D₂₃ are formed in the second well regions 721a, 721b, and 721c, respectively.

First p+-type regions 712a, 712b, and 712c and first n+-type regions 713a, 713b, and 713c are formed a predetermined distance apart, respectively, in their respective first well regions 711a, 711b, and 711c. The first p+-type regions 712a, 712b and 712c are the anodes of the first diodes D₁₁, D₁₂, and D₁₃, respectively, and the first n+-type regions 713a, 713b, and 713c are the cathodes of the first diodes D₁₁, D₁₂, and D₁₃, respectively. Second p+-type regions 722a, 722b, and 722c and second n+-type regions 723a, 723b, and 723c are formed a predetermined distance apart, respectively, in their respective second well regions 721a, 721b, and 721c. The second p+-type regions 722a, 722b, and 722c are the anodes of the second diodes D₂₁, D₂₂, and D₂₃, and the second n+-type regions 723a, 723b, and 723c are the cathodes of the second diodes D₂₁, D₂₂, and D₂₃, respectively. A metal wire is formed to connect the first p+-type region 712a of the first diode D₁₁ and the second n+-type region 723c of the second diode D₂₃ to the pad input terminal 210. A metal wire is formed to connect the first n+-type region 713c of the first diode D₁₃ and the second p+-type region 722a of the second diode D₂₁ to the input voltage terminal V_{DD}. Metal wires are formed to connect the first n+-type region 713a of the first diode D₁₁ with the first p+-type region 712b of the first diode D₁₂, and the first n+-type region 713b of the first diode D₁₂ with the first p+-type region 712c of the first diode D₁₃, in series, respectively. Metal wires are also formed to connect the second n+-type region 723a of the second diode D₂₁ with the second p+-type region 722b of the second diode D₂₂, and the second n+-type region 723b of the second diode D₂₂ with the second p+-type region 722c of the second diode D₂₃, in series, respectively.

Referring to FIG. 7B, third well regions 731a, 731b, and 731c of the second conductivity type (n-type) and fourth well regions 741a, 741b, and 741c of the second conductivity type (n-type) are formed on predetermined regions of the semiconductor substrate 700 of the first conductivity type (p-type). The third diodes D₃₁, D₃₂, and D₃₃ are formed in the third well regions 731a, 731b, and 731c, respectively. The fourth diodes D₄₁, D₄₂, and D₄₃ are formed in the fourth well regions 741a, 741b, and 741c, respectively.

Third p+-type regions 732a, 732b, and 732c and third n+-type regions 733a, 733b, and 733c are formed a predetermined distance apart, respectively, in their third well regions 731a, 731b, and 731c. The third p+-type regions 732a, 732b and 732c are the anodes of the third diodes D₃₁, D₃₂, and D₃₃, respectively, and the third n+-type regions 733a, 733b, and 733c are the cathodes of the third diodes D₃₁, D₃₂, and D₃₃, respectively. Fourth p+-type regions 742a, 742b, and 742c and fourth n+-type regions 743a, 743b, and 743c are formed a predetermined distance apart, respectively, in their respective fourth well regions 741a, 741b, and 741c. The fourth p+-type regions 742a, 742b, and 742c are the anodes of the fourth diodes D₄₁, D₄₂, and D₄₃, and the fourth n+-type regions 743a, 743b, and 743c are the cathodes of the fourth diodes D₄₁, D₄₂, and D₄₃, respectively. A metal wire is formed to connect the third p+-type region 732a of the third diode D₃₁ and the fourth n+-type region 743c of the fourth diode D₄₃ to the substrate terminal V_{SS}. A metal wire is formed to connect the third n+-type region 733c of the third diode D₄₃ and the fourth p+-type region 742a of the fourth diode D₄₁ to the pad input terminal 210. Metal wires are formed to connect the third n+-type region 733a of the third diode D₃₁ with the third p+-type region 732b of the third diode D₃₂, and the third n+-type region 733b of the third diode D₃₂ with the third p+-type region 732c of the third diode D₃₃, in series, respectively. Metal wires are also formed to connect the fourth n+-type region 743a of the fourth diode D₄₁ with the fourth p+-type region 742b of the fourth diode D₄₂, and the fourth n+-type region 743b of the fourth diode D₄₂ with the fourth p+-type region 742c of the fourth diode D₄₃ in series.

As described above, when ESD stress occurs, the electrostatic discharge protection circuit according to the present disclosure can make ESD current flow through diodes, which are positioned between a pad input terminal and an input voltage terminal and between the pad input terminal and a substrate terminal, only in a forward direction. Accordingly, the diodes do not flow current in a reverse direction, thereby preventing their characteristics from being deteriorated. In addition, it is possible to prevent a short circuit between the pad input terminal and the input voltage terminal from occurring during the normal operation of a circuit device and reduce the equivalent capacitance of a diode during operation of the circuit device at a high frequency.

Although the illustrative embodiments have been described herein with reference to the accompanying drawings, it is to be understood that the present disclosure is not limited to those precise embodiments, and that various changes and modifications may be affected therein by one of ordinary skill in the pertinent art without departing from the scope or spirit of the present disclosure. All such changes and modifications are intended to be included within the scope of the present disclosure as set forth in the appended claims.

What is claimed is:

1. An electrostatic discharge protection circuit positioned between a pad input terminal and a circuit device, the electrostatic discharge protection circuit comprising:
a first diode protection circuit unit comprising a first diode and a second diode, which are connected in parallel between the pad input terminal and the input voltage terminal and face opposite directions; and
a second diode protection circuit unit comprising a third diode and a fourth diode, which are connected in parallel between the pad input terminal and a substrate terminal and face opposite directions.

2. The electrostatic discharge protection circuit of claim 1, wherein the anode of the first diode and the cathode of the second diode are connected to the pad input terminal, and the cathode of the first diode and the anode of the second diode are connected to the input voltage terminal.

3. The electrostatic discharge protection circuit of claim 2, wherein the second diode comprises a plurality of diodes connected in series.

4. The electrostatic discharge protection circuit of claim 3, wherein the number of the plurality of diodes is determined such that when an input voltage is applied to the input voltage terminal, a short circuit between the pad input terminal and the input voltage terminal is prevented from occurring.

5. The electrostatic discharge protection circuit of claim 2, wherein the first diode comprises a plurality of diodes connected in series.

6. The electrostatic discharge protection circuit of claim 1, wherein the cathode of the third diode and the anode of the fourth diode are connected to the pad input terminal, and the anode of the third diode and the cathode of the fourth diode are connected to the substrate terminal.

7. The electrostatic discharge protection circuit of claim 6, wherein the fourth diode comprises a plurality of diodes connected in series.

8. The electrostatic discharge protection circuit of claim 7, wherein the number of the plurality of diodes is determined such that when an input voltage is applied to the input voltage terminal, a short circuit between the pad input terminal and the substrate terminal is prevented from occurring.

9. The electrostatic discharge protection circuit of claim 6, wherein the third diode comprises a plurality of diodes connected in series.

10. The electrostatic discharge protection circuit of claim 1 wherein the cathode of the first diode and the anode of the second diode are connected to the input voltage terminal, the anode of the first diode and the cathode of the second diode are connected to the pad input terminal, the cathode of the third diode and the anode of the fourth diode are also connected to the pad input terminal, and the anode of the third diode and the cathode of the fourth diode are connected to the substrate terminal.

11. The electrostatic discharge protection circuit of claim 10 wherein at least one of the first, second, third and fourth diodes comprises a plurality of diodes connected in series, the cathode of all but the last diode of the at least one plurality being connected to the adjacent anode of all but the first diode of the at least one plurality, respectively.

12. The electrostatic discharge protection circuit of claim 11 wherein the numbers of second and fourth diodes are determined such that when a nominal voltage potential exists between the input voltage terminal and the substrate terminal, current is substantially prevented from flowing between at least two of the input voltage terminal, the pad input terminal and the substrate terminal.

13. The electrostatic discharge protection circuit of claim 12 wherein the numbers of second and fourth diodes are substantially equal.

14. The electrostatic discharge protection circuit of claim 11 wherein the number of third diodes is determined such that when a substantially positive electrostatic discharge voltage potential exists between the pad input terminal and at least one of the input voltage terminal and the substrate terminal, the total breakdown voltage of the third diode is greater than the total threshold voltage of the fourth diode such that the third diode does not flow substantial current in a reverse direction.

15. The electrostatic discharge protection circuit of claim 11 wherein the number of first diodes is determined such that when a substantially negative electrostatic discharge voltage potential exists between the pad input terminal and at least one of the input voltage terminal and the substrate terminal, the total breakdown voltage of the first diode is greater than the total threshold voltage of the second diode such that the first diode does not flow substantial current in a reverse direction.

16. The electrostatic discharge protection circuit of claim 1 wherein the first and second diodes are formed on the same substrate.

17. The electrostatic discharge protection circuit of claim 1 wherein the third and fourth diodes are formed on the same substrate.

18. The electrostatic discharge protection circuit of claim 1 wherein the first, second, third and fourth diodes are formed on the same substrate.

19. The electrostatic discharge protection circuit of claim 11 wherein the numbers and sizes of first, second, third and fourth diodes are determined such that when a high frequency signal is applied to the pad input terminal, the reduced equivalent capacitance of diodes connected in series permits the use of larger diodes.

20. An electrostatic discharge protection circuit positioned between a pad input terminal and a circuit device and having a supply voltage terminal and a substrate voltage terminal, the electrostatic discharge protection circuit comprising:
first means for protecting the circuit device from a substantially positive electrostatic discharge by conducting current in a forward diode direction from the pad input terminal towards the supply voltage terminal;
second means for protecting the circuit device from a substantially negative electrostatic discharge by conducting current in a forward diode direction from the supply voltage terminal towards the pad input terminal;
third means for protecting the circuit device from a substantially negative electrostatic discharge by conducting current in a forward diode direction from the substrate voltage terminal towards the pad input terminal; and
fourth means for protecting the circuit device from a substantially positive electrostatic discharge by conducting current in a forward diode direction from the pad input terminal towards the substrate voltage terminal.

21. A method for protecting a circuit device having a supply voltage and a substrate voltage from an electrostatic discharge at a pad voltage, the method comprising:
protecting the circuit device from a substantially positive electrostatic discharge by conducting current in a forward diode direction from the pad voltage towards the supply voltage;
protecting the circuit device from a substantially negative electrostatic discharge by conducting current in a forward diode direction from the supply voltage towards the pad voltage;
protecting the circuit device from a substantially negative electrostatic discharge by conducting current in a forward diode direction from the substrate voltage towards the pad voltage; and
protecting the circuit device from a substantially positive electrostatic discharge by conducting current in a forward diode direction from the pad voltage towards the substrate voltage.
